(19) United States
(12) Patent Application Publication
(10) Pub. No.: US 2005/0118989 A1
(43) Pub. Date: Jun. 2, 2005

(54) Method of managing processing resources in a mobile radio system

(75) Inventor: Pascal Agin, Chatillon (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 10/969,905

(22) Filed: Oct. 22, 2004

(30) Foreign Application Priority Data
Oct. 24, 2003 (FR) 03 12 440

(51) Int. Cl. H04L 12/43

(52) U.S. Cl. 455/414.1; 455/403

(57) ABSTRACT

In one aspect, the present invention provides a method of managing processing resources in a mobile radio system, in which a “first” entity manages radio resources and corresponding processing resources, the processing resources being provided in a distinct, “second” entity, in which method: the second entity signals to the first entity a resource model representative of its processing capacity, based on spreading factor and on data rate; and the first entity manages said processing resources, on the basis of the signaled resource model, as a function of spreading factor and of data rate for the allocated radio resources.

The present invention relates in general to mobile radio systems, and more particularly to systems using code division multiple access (CDMA).

The CDMA technique is used in particular in so-called “third generation” systems, such as the universal mobile telecommunications system (UMTS).

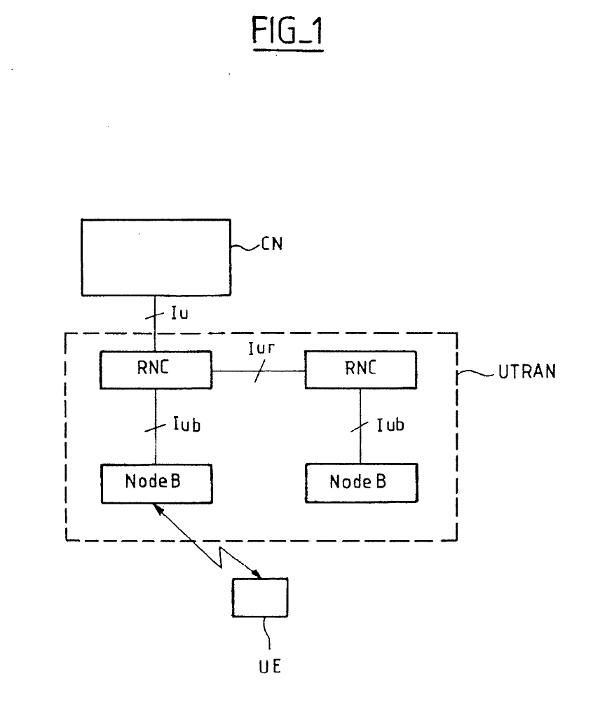

In general, as summarized in FIG. 1, a mobile radio network comprises a set of base stations and base station controllers. In the UMTS, the network is known as the UMTS Terrestrial Radio Access Network (UTRAN), a base station is known as a Node B, and a base station controller is known as a Radio Network Controller (RNC).

A mobile station is known as a User Equipment (UE), and the UTRAN communicates with mobile stations via a Uu interface and with a Core Network (CN) via an Iu interface.

As shown in FIG. 1, an RNC is connected:
to a Node B via an Iub interface,
to other RNC via an Iur interface, and
to the core network (CN) via an Iu interface.

The RNC controlling a given Node B is known as the Controlling Radio Network Controller (CRNC) and is connected to the Node B via the Iub interface. The CRNC has a load control function and a radio resource allocation and control function for each Node B that it controls.

For a given call relating to a given user equipment UE, there is a Serving Radio Network Controller (SRNC) that is connected to the core network via the Iu interface. The SRNC has a control function for the call concerned, including the functions of adding or removing radio links in accordance with the macrodiversity transmission technique, monitoring parameters likely to change during a call, such as bit rate, power, spreading factor, etc.

In CDMA systems, capacity limitations at the radio interface are fundamentally different from their counterparts in systems using other multiple access techniques, such as the Time Division Multiple Access (TDMA) technique. The TDMA technique is used in second generation systems such as the Global System for Mobile communications (GSM), for example. In CDMA systems, at any time all users share the same frequency resource. The capacity of these systems is therefore limited by interference, for which reason these systems are also known as soft limited systems.

This is why CDMA systems use algorithms such as load control algorithms to prevent, detect, and where applicable correct overloads, in order to avoid degraded quality, and call admission control algorithms to decide (as a function of diverse parameters such as the service required for the call, etc.) if the capacity of a cell that is not being used at a given time is sufficient for a new call to be accepted in that cell. In the remainder of the description, these algorithms are grouped together under the generic name load control algorithms.

They ordinarily use only radio criteria and are ordinarily executed in the CRNC, which does not have any information on the processing capacity of each Node B that it controls. It can therefore happen that the CRNC accepts a new call only for the call to be finally rejected because of a shortage of processing resources in the Node B, which leads to unnecessary additional processing in the CRNC and additional exchanges of signaling between the CRNC and the Node B.

Of course, it would be possible to avoid these problems by providing each Node B with sufficient processing resources to cover all situations, including that of maximum capacity (which corresponds to the situation of a very low level of interference). However, this would lead to costly base stations that would be rated more highly than necessary most of the time. Furthermore, in the case of progressive introduction of services offered by these systems, the processing capacity of the base stations can be limited at the start of deployment of these systems and progressively increased thereafter.

It would therefore be desirable for load control in such systems to allow for the processing capacity of each base station (Node B).

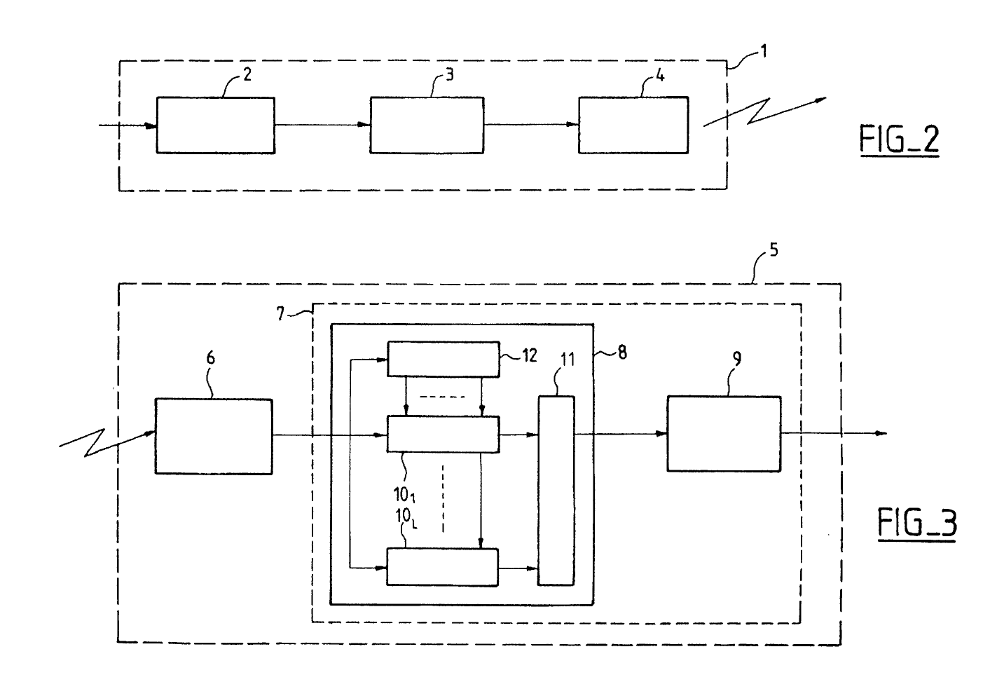

FIGS. 2 and 3 respectively outline the main transmit and receive processing used in a base station, for example a UMTS Node B.

FIG. 2 shows a transmitter 1 including:
channel coding means 2,
despreading means 3, and
radio frequency transmitter means 4.

These processing means are well known to the person skilled in the art and do not need to be described in detail here.

Channel coding uses techniques such as error corrector coding and interleaving to protect against transmission errors. This is also well known to the person skilled in the art.

Coding (such as error corrector coding) is intended to introduce redundancy into the information transmitted. The coding rate is defined as the ratio of the number of information bits to be transmitted to the number of bits actually transmitted or coded. Various quality of service levels can be obtained using different types of error corrector code. In the UMTS, for example, a first type of error corrector code consisting of a turbo code is used for a first type of traffic (such as high bit rate data traffic), while a second type of error corrector code consisting of a convolutional code is used for a second type of traffic (such as low bit rate data or voice traffic).

Channel coding generally also includes bit rate adaptation in order to adapt the bit rate to be transmitted to the bit rate offered for its transmission. Bit rate adaptation can include techniques such as repetition and/or puncturing, the bit rate adaptation rate then being defined as the repetition rate and/or the punch-through rate.

The raw bit rate is defined as the bit rate actually transmitted over the radio interface. The net bit rate is the bit rate obtained after deducting from the raw bit rate everything that is of no utility to the user, for example the redundancy introduced by the coding process.

Spreading uses spectrum spreading principles that are well known to the person skilled in the art. The length of the spreading code used is known as the spreading factor.

It should not be forgotten that, in a system such as the UMTS, the net bit rate (which is referred to hereinafter for simplicity as the bit rate) can vary during a call, and that the spreading factor can vary as a function of the bit rate to be transmitted.

FIG. 3 shows a receiver 5 including:
radio frequency receiver means 6,
received data estimation means 7, including despreader means 8 and channel decoder means 9.

These processing means are well known to the person skilled in the art and therefore do not need to be described in detail here.

FIG. 3 shows an example of processing carried out in the despreader means 8. The processing is carried out in a rake receiver to improve the quality of received data estimation using multi-path phenomena, i.e. propagation of the same source signal along multiple paths, such as results from multiple reflections from elements in the environment, for example. Unlike TDMA systems, CDMA systems can exploit the multiple paths to improve received data estimation quality.

A rake receiver has a set of L fingers 10₁ to 10_{L} and means 11 for combining signals from the fingers. Each finger despreads the signal received via one of the paths that are taken into account, as determined by means 12 for estimating the impulse response of the transmission channel. To optimize received data estimation quality, the means 11 combine the despread signals corresponding to the paths that are taken into account.

The reception technique using a rake receiver is also used in conjunction with the macrodiversity transmission technique, whereby the same source signal is transmitted simultaneously to the same mobile station by a plurality of base stations. By using a rake receiver, the macrodiversity transmission technique not only improves receive performance but also minimizes the risk of call loss during handover. For this reason it is also known as soft handover, as compared to hard handover, in which a mobile station is connected to only one base station at any given time (or to only one sector of a given base station).

The received data estimating means can also use various techniques for reducing interference, such as the multi-user detection technique.

It is also possible to use a plurality of receive antennas. To optimize received data estimation quality the received data estimator means then further include means for combining signals received via the multiple receive antennas.

Channel decoding includes functions such as deinterleaving and error corrector decoding. Error corrector decoding is generally much more complex than error corrector coding and can use techniques such as maximum likelihood decoding, for example. A Viterbi algorithm can be used for convolutional codes, for example.

To be able to process several users simultaneously, a base station (Node B) includes transmitters and receivers such as the transmitter and the receiver outlined above and therefore requires a high receive processing capacity for received data estimation.

As mentioned above, for monitoring the load in a system such as the UMTS, for example, it is therefore desirable to take account of the processing capacity of a base station.

For the UMTS, for example, the 3G document TS 25.433 published by the 3^{rd} Generation Partnership Project (3GPP) specifies that, for each value of the spreading factor (SF) for which there is provision within the system, the Node B must signal to the CRNC its overall processing capacity (also known as the capacity credit) and the amount of that overall processing capacity (also known as the consumption cost) that is necessary for allocating a physical channel. The set of all consumption costs for all possible values of the spreading factor is also known as the capacity consumption law. The capacity credit and the capacity consumption law, taken together, are also known as the resource model. This information is signaled by a Node B to the CRNC each time that the processing capacity of the Node B changes, using a Resource Status Indication message, or in response to a request from the CRNC, using an Audit Response message.

In a first prior patent application (the French patent application published under the No. 2 813 006, and filed Aug. 10, 2000 by the Applicant) it is stated that this kind of solution is not suitable for taking account of processing capacity limitations in a Node B, for the following reasons:
The channel decoding processing depends on the net bit rate rather than the gross bit rate or the spreading factor. For example, considering a spreading factor of 128 (and thus a raw bit rate of 30 kbit/s), the net bit rate can have different values depending on the coding rate and the bit rate adaptation rate, and the net bit rate can typically vary from 5 to 15 kilobits per second (kbit/s). Consequently, for a fixed spreading factor, the amount of processing in the Node B can vary significantly (for example by a factor exceeding 3). This is not taken into account in the prior art solution.
The number of fingers of the rake receiver required for transmission channel and data estimation is highly dependent on the number of a radio links. In the prior art solution, the maximum number of fingers of the rake receiver in the Node B cannot be taken into account in algorithms such as load control algorithms or call admission control algorithms, as this type of limitation is not linked to the spreading factor.
The processing capacity signaled by the Node B to the CRNC is an overall processing capacity that cannot take account of limitations in the processing capacity of the Node B.

The first prior patent application proposes another approach whereby, to take account of limitations in the processing capacity of a Node B, the Node B signals to the CRNC one or more parameters representative of traffic load, such as, in particular, the maximum number of radio links that can be established, and the maximum net data rate for the established radio links, possibly in each transmission direction and/or for each type of channel coding that can be used. For more information, reference may be made to said first prior patent application.

In a second prior patent application (the French patent application published under the No. 2 819 658, filed on Jan. 12, 2001 by the Applicant), another approach is proposed in which the concept of overall processing capacity, or “capacity credit”, is retained, but the allocation cost is no longer signaled for each possible value of spreading factor but for different possible values of data rate. In particular, the allocation cost can be signaled for typical data rates known as reference rates, and the allocation cost can subsequently be determined for any data rate value on the basis of the costs signaled for the reference rates, and by using interpolation techniques. For further information, reference can be made to said second prior patent application.

In a third prior patent application (the French patent application published under the No. 2 826 808, filed on Jun. 29, 2001 by the Applicant), a solution is also proposed for solving the following problems. All present equipment using a resource model based on spreading factor (in the present state of the standard) cannot necessarily be modified to be capable of using a resource model based on data rate (using the approach considered in the above-outlined second prior patent application). In addition, in future equipment, the possibility of using a resource model based on spreading factor in addition to a resource model based on data rate might possibly be maintained. A compatibility problem would then arise between various types of equipment, depending on the type of resource model used.

In that third prior patent application, proposals are made in particular for an additional signaling protocol in which a Node B supporting both types of resource model signals not only the model itself, but the type of model used. For further information, reference can be made to that third prior patent application.

The present invention is based on a different approach, serving to solve all or part of the problems presented above.

One of the aspects of the present invention is a method of managing processing resources in a mobile radio system, in which a “first” entity manages radio resources and corresponding processing resources, the processing resources being provided in a distinct, “second” entity, in which method:
the second entity signals to the first entity a resource model representative of its processing capacity, based on spreading factor and on data rate; and
the first entity manages said processing resources, on the basis of the signaled resource model, as a function of spreading factor and of data rate for the allocated radio resources.

According to another characteristic:
the information signaled by the second entity, representative of said resource model, comprise an overall processing capacity, or “capacity credit”, and a consumption law giving the quantity of said overall processing capacity that is needed for allocating radio resources, as a function of spreading factor and as a function of data rate; and
said management of processing resources by said first entity includes updating the capacity credit on each radio resource allocation, on the basis of said consumption law, as a function of spreading factor and of data rate for the allocated radio resources.

According to another characteristic, the information signaled by the second entity, representative of said resource model based on spreading factor and on data rate, comprises “first” information representative of a resource model based on spreading factor and representative of a portion of said processing capacity, and “second” information representative of a resource model based on data rate and representative of another portion of said processing capacity.

According to another characteristic, said first information comprises at least a “first” allocation cost corresponding to the quantity of overall processing capacity needed for radio resource allocation for a spreading factor value, and said second information includes at least a “second” allocation cost corresponding to the quantity of the overall processing capacity needed for radio resource allocation for a data rate value.

According to another characteristic, different allocation costs are provided for different predetermined data values referred to as “reference” data rates.

According to another characteristic, the consumption cost for said corresponding bit rate is obtained from the consumption costs for reference bit rates.

According to another characteristic, the consumption cost for said corresponding bit rate is obtained from the consumption costs for reference bit rates by interpolation.

According to another characteristic, when the bit rate R is not a reference bit rate, the consumption cost is calculated as a function of consumption costs C_{inf} and Cₛᵤₚ corresponding to the reference bit rates R_{inf} and Rₛᵤₚ that are the closest to the bit rate R and where R_{inf}<Rₛᵤₚ in accordance with the following equation:

$${Consumption}_{—} cost = {C}_{inf} + \frac{R - {R}_{inf}}{{R}_{sup} - {R}_{inf}} ( {C}_{sup} - {C}_{inf} )$$

According to another characteristic, the consumption cost is set at zero if the interpolation result is negative.

According to another characteristic, said corresponding bit rate corresponds to a maximum bit rate.

According to another characteristic, said maximum bit rate is obtained from the equation:

$$Maximum\_bit \_rate = {Max}_{j} {br}_{j}$$

where:

$${br}_{j} = {\sum }_{k = 1}^{n} \frac{{N}_{k}^{( j )} {L}_{k}^{( j )}}{{TTI}_{k}}$$

and in which brⱼ is the bit rate of j^{th} transport format combination (TFC) in the TFCS, n is the number of transport channels in the CCTrCh, Nₖ^{(j)} and Lₖ^{(j)} are respectively the number of transport blocks and the size of the transport blocks expressed as a number of bits for the k^{th} transport channel in the j^{th} TFC, and TTIₖ is the transmission time interval (TTI) expressed in seconds of the k^{th} transport channel.

According to another characteristic, said corresponding bit rate corresponds to an effective bit rate.

In another aspect, the present invention provides a mobile radio system for implementing such a method.

In particular, according to another characteristic, such a system comprises:
in the second entity, means for signaling to the first entity a resource model based on spreading factor and on data rate; and
in the first entity, means for managing said processing resources on the basis of the signaled resource model as a function of spreading factor and of data rate for the allocated radio resources.

In another aspect, the present invention provides a base station for a mobile radio system, for implementing such a method.

In particular, according to another characteristic, the base station includes:
means for signaling to a base station controller a resource model based on spreading factor and on data rate.

In another aspect, the present invention provides a base station controller for a mobile radio system, for implementing such a method.

In particular, according to another characteristic, the base station controller comprises:
means for receiving from a base station a resource model based on spreading factor and on data rate; and
means for managing said processing resources on the basis of the signaled resource model as a function of spreading factor and of data rate for the allocated radio resources.

The present invention also provides a method of managing processing resources in a mobile radio system, in which a “first” entity manages radio resources and corresponding processing resources, which processing resources are provided in a distinct, “second” entity, in which method:
the second entity signals to the first entity a resource model representative of its processing capacity, such that:
   if the second entity supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
   if the second entity supports only a resource model based on spreading factor, the information signaled by the second entity, representative of said second resource model, comprises only information representative of a resource model based on spreading factor;
the first entity manages said processing resources on the basis of the signaled resource model as a function of spreading factor and of data rate, or as a function of spreading factor alone, as the case may be, for the allocated radio resources.

According to another characteristic, if the second entity supports both a resource model based on spreading factor and on data rate, and a resource model based on spreading factor, it selects one of the two models as being more representative of its processing capacity, and it signals the selected resource model to the first entity.

According to another characteristic:
the information signaled by the second entity and representative of a resource model comprises an overall processing capacity or “capacity credit” and a consumption law indicating the quantity of said overall processing capacity that is needed for allocating radio resources as a function of both spreading factor and data rate, or as a function of spreading factor only, as appropriate; and
said management of processing resources by said first entity comprises updating the capacity credit on each radio resource allocation on the basis of said consumption law as a function of spreading factor and data rate or as a function of spreading factor alone, as appropriate, for the allocated radio resources.

According to another characteristic, said first information comprises at least a “first” allocation cost corresponding to the quantity of overall processing capacity needed for allocating radio resources, for a value of spreading factor, and said second information comprises at least a “second” allocation cost corresponding to the quantity of overall processing capacity needed for allocating radio resources for a data rate value.

In another aspect, the present invention also provides a mobile radio system for implementing such a method.

In particular, according to another characteristic:
the second entity includes means for signaling to the first entity a resource model representative of its processing capacity, such that:
   if the second entity supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
   if the second entity supports only a resource model based on spreading factor, the information signaled by the second entity, representative of said second resource model, comprises only information representative of a resource model based on spreading factor;
the first entity including means for managing said processing resources on the basis of the signaled resource model as a function of spreading factor and data rate or as a function of spreading factor alone, as appropriate, for the allocated radio resources.

In another aspect, the present invention provides a base station for a mobile radio system for implementing such a method.

In particular, according to another characteristic, the base station comprises:
means for signaling to a base station controller a resource model representative of its processing capacity, such that:
   if the base station supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
   if the base station supports only a resource model based on spreading factor, the information signaled by the second entity, representative of said second resource model, comprises only information representative of a resource model based on spreading factor.

In another aspect, the present invention provides a base station controller for a mobile radio system for implementing such a method.

In particular, according to another characteristic, the base station controller comprises:
means for receiving from a base station a resource model representative of its processing capacity, such that:
   if the base station supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
   if the base station supports only a resource model based on spreading factor, the information signaled by the second entity, representative of said second resource model, comprises only information representative of a resource model based on spreading factor;
means for managing said processing resources on the basis of the signaled resource model as a function of spreading factor and of data rate, or as a function of spreading factor alone, as appropriate, for the allocated radio resources.

Other objects and features of the present invention become apparent on reading the following description of embodiments of the invention, which is given with reference to the accompanying drawings, in which:

FIG. 1, described above, outlines the general architecture of a mobile radio system such as the UMTS,

FIGS. 2 and 3, also described above, outline the main transmit and receive processing effected in a base station, such as a UMTS Node B, and

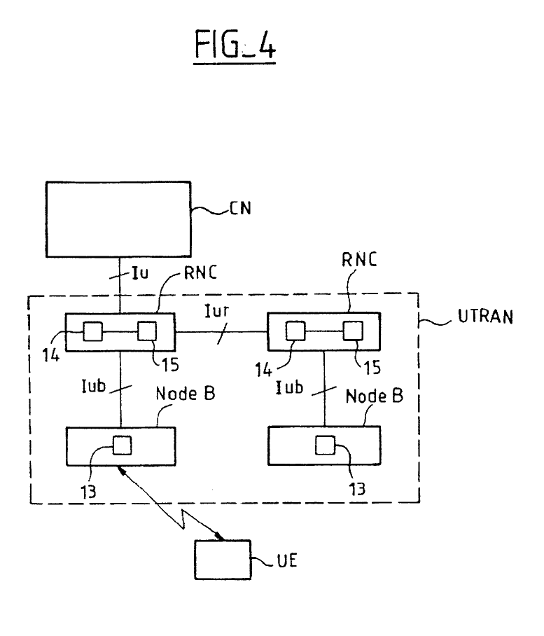

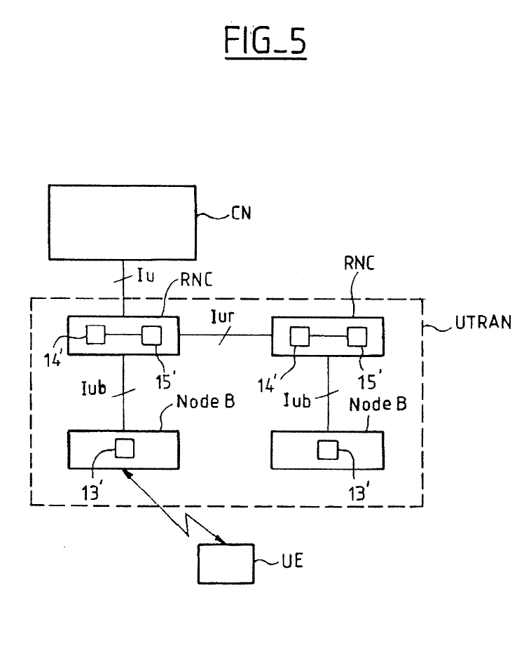

FIGS. 4 and 5 are diagrams for illustrating implementations of methods of the invention.

The present invention may also be explained as follows.

Firstly, the present state of the standard, corresponding to version R5 (similar to versions R99 and R4), is briefly outlined below.

The present state of the standard is described in specification 3GPP TS 25.433 V5.2.0, principally in its sections:
9.2.1.9A “Common Channels Capacity Consumption Law”;
9.2.1.20A “Dedicated Channels Capacity Consumption Law”.

The processing capacity of a Node B can be signaled to the to the CRNC in two Node B application part (NBAP) messages, where NBAP designates a signaling protocol used over the Iub interface between a Node B and a CRNC:
a resources status indication message; and
an audit response message.

The processing capacity of the Node B is represented by:
a capacity credit which represents the total processing resources of the Node B. A capacity credit can be specified for each of the directions: “up-link”, i.e. transmission from mobile stations to the network; and “down-link”, i.e. transmission from the network to mobile stations; and
a consumption law which gives the estimated quantity of processing resources used by the Node B for a new radio link (RL) or to reconfigure an existing radio link.

There are two consumption laws: one for common channels and another for dedicated channels. Each consumption law specifies the cost of a radio link (i.e. “RL cost”) in the up direction (i.e. “UL cost”), and for the down direction (i.e. “DL cost”) for each possible spreading factor.

In addition, for the consumption law for dedicated channels, it is also possible to specify an additional cost, up or down, for each new radio link set (RLS). Such additional RLS costs are taken into account in addition to the RL costs whenever a new radio link is created (which, when only one RLS is used by the UE, is equivalent to setting up a first radio link).

The ways in which the downlink shared channel (DSCH) and the multi-code cases are processed are also specified in the above-referenced specification, and also for the invention of another prior patent application (the French patent application published under the No. 2 821 515) filed by the Applicant. For the DSCH case, a processing cost associated with the DSCH (equal to the “DL RL cost”) is taken into account when a DSCH is allocated, or deleted, or reconfigured. For the multi-code case, the costs given in the consumption law are the costs per spreading code (or “channelization code”) and when multiple spreading codes are used, the processing cost is taken as being N times the cost of one code, where N is the number of codes.

As recalled above, in the French patent application published under the No. 2 819 658, filed by the Applicant, a credit mechanism is proposed that is similar, but based on data rate instead of spreading factor. The same signaling that is used for the credit mechanism based on spreading factor can be used, but instead of interpreting the consumption law as costs per spreading factor, it is interpreted as costs given for different data rates, and in particular for reference data rates.

Unlike that prior patent application, the present invention does not propose signaling the credit mechanism on the basis of data rate, instead of signaling the credit mechanism on the basis of spreading factor, but to signaling it in addition.

By way of example, this can be done in two ways:
either by adding a specific new consumption law to the existing consumption law which is based on spreading factor, the new law being based on data rate (which law itself may comprise a new law for dedicated channels, and a new law for common channels); or
else by adding to the existing costs or to the existing consumption law based on spreading factor, new costs corresponding to a credit mechanism based on data rate (these added costs themselves possibly comprising, for the consumption law for dedicated channels, a radio link cost (RL cost), and possibly also an additional cost (RLS cost).

The cost for a new radio link, or for a reconfigured radio link (it being understood that in the event of a radio link being reconfigured, the cost corresponds to the difference between the new cost after reconfiguration and the old cost prior to reconfiguration), can then be calculated as follows:
cost=cost1+cost2
where cost1 is a cost which is a function of the spreading factor of the radio link calculated on the basis of consumption laws based on spreading factor (SF) such as those specified in the present standard, and where cost2 is a cost which is a function of the data rate of the radio link, as proposed in the prior above-mentioned patent application published under the No. 2 819 658, the content of which is, as a result, considered as forming part of the present application. Nevertheless, the description below recalls the main teaching of that prior application.

As outlined above, in that prior application, the concept of overall processing capacity, or “capacity credit” is conserved, but the allocation cost is not signaled for each possible value of the spreading factor, but for different possible values of data rate.

In addition, that prior application also sets out to solve novel problems that arise with such an approach based on data rate.

A first problem is that whereas the number of possible spreading factors is finite (for example, in the UMTS system, there are eight possible spreading factor values: 4, 8, 16, 32, 64, 128, 256, 512), the data rate can take any positive value. It will be understood that it is not possible or realistic in practice for a Node B to signal to the CRNC an allocation cost for all possible values of data rate.

A second problem is that in order to update the capacity credit each time resources are allocated, as a function of the corresponding data rate, the CRNC does not have the data rate available, at least in the present state of the standard. In contrast, in the above-outlined prior technique, the CRNC does know the spreading factor since the spreading factor is signaled by the SRNC to the CRNC when a new radio link is added, removed, or reconfigured.

A third problem is that the data rate need not be fixed, but may vary. In contrast, the spreading factor, at least in the down direction, is fixed.

To solve the first problem mentioned above, the cost is signaled for only a few typical values of the bit rate, referred to hereinafter as reference bit rates, and a solution is additionally proposed for determining the cost for any bit rate value from the costs signaled for the reference bit rates. For example, linear interpolation can be used (this is the simplest solution), ensuring that the cost always remains positive (i.e. if the result of the interpolation is negative, the resultant cost is zero).

For example, when the bit rate R is not a reference bit rate, the Consumption_cost is calculated as a function of costs C_{inf} and Cₛᵤₚ corresponding to the reference bit rates R_{inf} and Rₛᵤₚ which are the closest to the bit rate R and where R_{inf}<Rₛᵤₚ using the following equation:

$${Consumption}_{—} cost = {C}_{inf} + \frac{R - {R}_{inf}}{{R}_{sup} - {R}_{inf}} ( {C}_{sup} - {C}_{inf} ) \qquad ( 1 )$$

If the result is negative, the consumption cost can be set at zero, i.e.:

7 Consumption_cost=0

Other interpolation techniques can be used, of course.

The reference bit rates can be 4.75 kbit/s, 12.2 kbit/s, 64 kbit/s, 144 kbit/s, 384 kbit/s, and 2048 kbit/s, for example.

Furthermore, in a system such as the UMTS, for example, one solution to the second and third problems previously mentioned is to derive the bit rate as a function of a transport format combination set (TFCS) parameter.

It should not be forgotten that one feature of a system like the UMTS is the possibility of transporting a plurality of services on the same connection, i.e. a plurality of transport channels (TrCH) on the same physical channel. The transport channels are processed separately in accordance with a channel coding scheme (including error detector coding, error corrector coding, bit rate adaptation and interleaving, see FIG. 2) before they are time division multiplexed to form a coded composite transport channel (CCTrCH) to be transmitted on one or more physical channels. For more information on these aspects of the UMTS, see the 3G document TS 25.212 V3.0.0 published by the 3GPP.

It should also not be forgotten that another feature of a system like the UMTS is that it allows users to use bit rates that can vary during a call. The data transported by the transport channels is organized into data units known as transport blocks that are received periodically at a transmission time interval (TTI). The number and the size of the transport blocks received for a given transport channel vary as a function of the bit rate. The transport format is defined as the known number and size of the transport blocks (and thus the instantaneous bit rate) for a given transport channel. The transport format combination (TFC) is defined as a combination of transport formats authorized for different transport channels to be multiplexed onto the same coded composite transport channel. Finally, the transport format combination set (TFCS) is defined as the set of all possible combinations of transport formats. For more information on these aspects of the UMTS see the 3G document TS 25.302 V3.7.0 published by the 3GPP.

The bit rate for each TFC within a TFCS can then be calculated using the following equation, in which brⱼ is the bit rate of the j^{th} TFC in the TFCS, n is the number of transport channels in the CCTrCh, Nₖ^{(j)} and Lₖ^{(j)} are respectively the number of transport blocks and the size of the transport blocks (expressed as a number of bits) for the k^{th} transport channel in the j th TFC, and TTIₖ is the transmission time interval (expressed in seconds) of the k^{th} transport channel:

$${br}_{j} = {\sum }_{k = 1}^{n} \frac{{N}_{k}^{( j )} {L}_{k}^{( j )}}{{TTI}_{k}} \qquad ( 2 )$$

Other formulas can be used, of course, depending on how the bit rate for the data to be processed is defined.

Furthermore, the problem is that the bit rate is not fixed, but can vary (i.e. any TFC within the TFCS can be used during a call), and the variation is not known a priori to the Node B or the UE, and in fact cannot be known a priori. The simplest solution is to consider only the maximum bit rate or the bit rate that maximizes the consumption cost (which is usually equal to the maximum bit rate, but this is not always the case), for all the TFC within the TFCS. If a new radio link is accepted, it is necessary to verify that the Node B has sufficient resources to process bit rates up to the maximum bit rate authorized for the new radio link.

If the maximum bit rate is defined as follows:

$$\begin{matrix}{Maximum}_{—} {bit}_{—} rate = {max}_{j} {br}_{j} \\ equation ( 1 ) then becomes \text{:} & ( 3 ) \\ {Consumption}_{—} cost = {c}_{inf} + \frac{{Maximum}_{—} {bit}_{—} rate - {R}_{inf}}{{R}_{sup} - {R}_{inf}} ( {C}_{sup} - {C}_{sup} ) & ( 4 )\end{matrix}$$

Furthermore, the method may be performed overall for both transmission directions (up and down) or for each transmission direction (with the up and down directions being processed separately): in which case, a total credit is given for each direction and the allocation cost is given for each reference data rate for each direction.

Moreover, the above-described solution example consisting in considering only the maximum bit rate, although simpler, nevertheless has the drawback that the processing resources reserved in this way in the Node B are probably overestimated, since processing resources corresponding to the maximum bit rate are reserved on each occasion. It may then happen that some processing resources are still available, although the credit is exhausted. In this case, a new radio link or common transport channel request could be refused, even if sufficient processing resources are in fact available in the Node B.

One solution to this would be for the CRNC to calculate the remaining credit not on the basis of the maximum bit rate but instead on the basis of the effective bit rate. The current TFC knows the effective bit rate, as explained above. In this case, the Node B would still signal the same information to the CRNC, and only the algorithm for updating the remaining credit, which is implemented in the CRNC, would change: it would then be necessary to update the credit more frequently (each time that the TFC changes).

For dedicated channels (DCH), one problem in implementing this kind of solution is that call admission control is implemented in the CRNC which, according to the current version of the technical specifications, does not know the instantaneous TFC (the CRNC knows only the TFCS, and the UE, the Node B and the SRNC know the TFC). Nevertheless, this kind of solution could be applicable with appropriate signaling, or if call admission control were implemented in an entity knowing this information.

For common transport channels (including the DSCH) this kind of solution would seem to be applicable according to the current version of the technical specifications (both for the up-link direction and for the down-link direction), since the MAC-c/sh function (which chooses the TFC for the common and shared channels) is implemented in the CRNC.

Moreover, if a plurality of transport channels is multiplexed onto a physical channel and the transport channels do not require the same processing resources, for example because one uses a convolutional code and the other uses a turbo code, in order to avoid the drawbacks due to the fact that the cost is chosen as a function of the overall bit rate, without taking into account the fact that the two transport channels require different processing resources, one solution would be to signal the consumption cost per bit rate and per transport channel, the CRNC calculating the total cost for all the transport channels as a function of the transport channel types. This kind of solution would make it possible to distinguish between the various transport channels, thus allowing different consumption costs for different transport channels having different characteristics. As previously described, the consumption costs can be based on the maximum bit rate of the transport channel concerned (which is given by the TFCS) or the effective bit rate (which is given by the current TFC).

It would also be possible to provide a cost as a function of the different data rate for each time of error correcting code (convolutional code or turbo-code, in particular). Under such circumstances, there would be, for example, two costs for each reference data rate, one for use with turbo-code, and the other for use otherwise.

As mentioned above, the existing mechanisms described in the specification 3GPP TS 25.433 could be reused insofar as the method of the invention uses a resource model based on spreading factor.

Some of those mechanisms could also be reused insofar as the method of the invention uses a resource model based on data rate. As an example of mechanisms which could be reused, mention can be made in particular of the DSCH. Alternatively, distinct mechanisms could be used.

By way of example of a case in which distinct mechanisms could be preferred, mention can be made of the following in particular:
the multi-code case: in this case it may be preferable for the data rate cost function to be applied regardless of the number of codes; and
the case of creating a first radio link (RL) of a radio link set (RLS): in which case it may be preferable not to apply, nor even to signal, the additional cost (RLS cost) when the cost is a function of data rate.

Alternatively, similar mechanisms could be used.

In one of the various aspects of the present invention, the concept of overall processing capacity (or “capacity credit”) is retained, but the allocation cost is no longer signaled for different values of the spreading factor or for different values of data rate, but for different values of spreading factor and for different values of data rate. As has been observed by the Applicant, data rate is more representative of the processing capacity of a Node B than is spreading factor, at least for certain kinds of processing (such as, in particular, processing for encoding and decoding error corrections), and for certain other kinds of processing (in particular spreading and unspreading processing), the spreading factor can be retained as being representative of the processing capacity of a Node B.

In still other terms, in one of the various aspects of the invention, in a method of managing processing resources in a mobile radio system, in which a so-called “first” entity (in particular a base station controller or CRNC in a system of the UMTS type), manages radio resources and the corresponding processing resources, the processing resources are provided in an entity which is distinct therefrom and referred to as the “second” entity (in particular a base station or a Node B in a system such as the UMTS):
the second entity signals to the first entity a resource model representative of its processing capacity, based on spreading factor and on data rate; and
the first entity manages said processing resources on the basis of the signaled resource model, as a function of spreading factor and as a function of data rate for the allocated radio resources.

Advantageously:
the information signaled by the second entity and representative of a resource model comprises an overall processing capacity or “capacity credit” and a consumption law indicating the quantity of said overall processing capacity that is needed for allocating radio resources as a function of both spreading factor and data rate, or as a function of spreading factor only, as appropriate; and
said management of processing resources by said first entity comprises updating the capacity credit on each radio resource allocation on the basis of said consumption law as a function of spreading factor and data rate or as a function of spreading factor alone, as appropriate, for the allocated radio resources.

Advantageously, the information signaled by the second entity representative of said resource model based on spreading factor and on data rate comprises “first” information representative of a resource model based on spreading factor representative of a portion of said processing capacity, and “second” information representative of a resource model based on data rate, and representative of another portion of said processing capacity.

Advantageously, said first information comprises at least a “first” allocation cost corresponding to the quantity of overall processing capacity needed for radio resource allocation, for a particular spreading factor value, and said second information comprises at least a “second” allocation cost corresponding to the quantity of overall processing capacity needed for radio resource allocation, for a particular data rate value.

The term “radio resource allocation” is intended to encompass all operations likely to modify the allocation of radio resources within the system, including not only allocation operations as such, but also deallocation and reconfiguration operations.

Thus in the UMTS, these operations correspond:
for the dedicated transport channels, to the radio link set-up, radio link addition, radio link deletion, and radio link reconfiguration procedures defined in the 3G document TS 25.433 published by the 3GPP, and
for the common transport channels, to the common transport channel set-up, common transport channel deletion, and common transport channel reconfiguration procedures also defined in the 3G document TS 25.433 published by the 3GPP.

The term “updating” the capacity credit is intended to cover not only operations which debit the capacity credit, when new radio resources are required, but also operations which credit the capacity credit, when radio resources are no longer necessary and are therefore released.

Accordingly:
the capacity credit is debited for the radio link set-up, radio link addition and common transport channel set-up procedures,
the capacity credit is credited for the radio link deletion and common transport channel deletion procedures, and
for the RL reconfiguration and the CTCH reconfiguration cases, the capacity credit is debited or credited with the difference between the new cost (after reconfiguration) and the old cost (prior to reconfiguration) depending on whether the difference is positive or negative.

In addition, to cover all possibilities for defining data rate in such systems, the data rate can be a bit rate, a symbol rate, or a chip rate. This rate taken into consideration is preferably a net rate.

The distinction between bit rate and symbol rate is usually made in systems that make use of a plurality of possible kinds of modulation. Modulation is the processing which transforms the information to be transmitted into an analog signal capable of carrying said information. Various modulation techniques are known and they are characterized by their spectrum efficiency, i.e. their ability to transmit a greater or smaller number of bits per symbol, with transmitted bit rate increasing with modulation efficiency, for given allocated frequency band.

The term chip rate is used to designate the data rate after spreading (where the term “chip” conventionally designates the unit transmission period of the signal obtained after spreading).

FIG. 4 is a diagram for illustrating the example of means to be provided in accordance with the invention in a base station (or a Node B in a system such as the UMTS), and in a base station controller (or an RNC for a system such as the UMTS), for implementing such a method.

A base station referenced Node B thus includes (in addition to other means which may be conventional means):
means referenced 13 for signaling to a base station controller a resource model representative of its processing capacity, based on spreading factor and data rate.

A base station controller referenced RNC thus includes (in addition to other means which may be conventional means):
means referenced 14 for receiving from a base station a resource model based on spreading factor and on data rate; and
means referenced 15 for managing said processing resources on the basis of the signals resource model, as a function of spreading factor or data rate for the allocated radio resources.

These various means can operate using the above-described method; the particular way in which they are embodied does not present any particular difficulty for the person skilled in the art, so such means do not need to be described herein in a manner more detailed than by describing their functions.

Furthermore, other aspects of the present invention can also be explained as follows.

In order to solve the problem of compatibility with old equipment, the new consumption laws or the new costs (using the concepts used above) can be provided in optional manner: in which case, only existing laws or existing costs (using the concepts used above) need be taken into account by the CRNC.

The compatibility problem could then be solved in the following manner, for example.

In the description below, the resource model of the invention, based on spreading factor and on data rate, is also referred to as the new resource model, and the resource model based on spreading factor, as specified in the present state of the standard, is also referred to as the existing resource model.

Below, the term “new CRNC” (or “new Node B”) designates a CRNC (or a Node B) supporting at least the new resource model, and the term “old CRNC” (or “old Node B”) designates a CRNC (or a Node B) supporting only the existing resource model.

Below, there is also considered, by way of example, the case of a new Node B that supports both the new resource model and the old resource model selecting one or other of those resource models as being the most representative of its processing capacity, and signaling to the CRNC which resource model it has selected in this way.

Below, there is also considered, by way of example, the case of new costs rather than of a new law (using the concepts used above).

It is then possible, for example, to distinguish between the following circumstances:
New CRNC+new Node B

Under such circumstances, the Node B signals either existing costs only (based on spreading factor), or both existing costs (based on spreading factor) and new costs (based on data rate), and the CRNC takes account of the costs signaled in this way in order to estimate the processing resources that remain in the Node B.
Old CRNC+old Node B

In this circumstance, the Node B signals existing costs only (based on spreading factor), and the CRNC takes account of the costs signaled in this way in order to estimate the processing resources remaining in the Node B.
New CRNC+old Node B

In this circumstance, the Node B signals existing costs only (based on spreading factor), and the CRNC takes account of the costs signaled in this way in order to estimate the processing resources remaining in the Node B.
Old CRNC+new Node B

In this circumstance, the Node B signals either existing costs only (based on spreading factor), or both existing costs (based on spreading factor) and new costs (based on data rate). Only the existing costs (based on spreading factor) are taken into consideration by the CRNC for estimating the processing resources that remain in the Node B. In this circumstance, the problem of compatibility is not solved, if the Node B signals both the existing costs (based on spreading factor) and the new costs (based on data rate), since the resource model is interpreted differently in the Node B and in the CRNC. However, this circumstance is highly unlikely, since when network equipment is upgraded, the RNCs are generally updated before the Nodes B (where such upgrading is much easier for RNCs since there are many fewer RNCs than there are Nodes B). Nevertheless, one solution for solving the problem would be to allow the CRNC to signal to the Node B which mechanisms it supports, in particular using the Node B application part (NBAP) signaling protocol, e.g. in the cell setup request message, so that a new Node B does not use the new credit mechanism with an old CRNC.

In other words, in another aspect of the invention, in a method of managing processing resources in a mobile radio system in which a “first” entity (in particular a base station controller or CRNC in a system such as the UMTS) manages radio resources and the corresponding processing resources, which processing resources are provided in a distinct entity known as a “second” entity (in particular a base station or a Node B in a system such as the UMTS):
the second entity signals to the first entity a resource model representative of its processing capacity, such that:
   if the second entity supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
   if the second entity supports only a resource model based on spreading factor, the information signaled by the second entity, representative of said second resource model, comprises only information representative of a resource model based on spreading factor;
the first entity manages said processing resources on the basis of the signaled resource model as a function of spreading factor and of data rate, or as a function of spreading factor alone, as the case may be, for the allocated radio resources.

Advantageously, if the second entity supports both a resource model based on spreading factor and on data rate, and a resource model based on spreading factor, it selects one of the two models as being more representative of its processing capacity, and it signals the selected resource model to the first entity.

Advantageously:
the information signaled by the second entity and representative of a resource model comprises an overall processing capacity or “capacity credit” and a consumption law indicating the quantity of said overall processing capacity that is needed for allocating radio resources as a function of both spreading factor and data rate, or as a function of spreading factor only, as appropriate; and
said management of processing resources by said first entity comprises updating the capacity credit on each radio resource allocation on the basis of said consumption law as a function of spreading factor and data rate or as a function of spreading factor alone, as appropriate, for the allocated radio resources.

Advantageously, said first information comprises at least a “first” allocation cost corresponding to the quantity of overall processing capacity needed for allocating radio resources, for a value of spreading factor, and said second information comprises at least a “second” allocation cost corresponding to the quantity of overall processing capacity needed for allocating radio resources for a data rate value.

FIG. 5 is a diagram for illustrating an example of the means to be provided in accordance with the invention in a base station (or a Node B in a system such as the UMTS), and in a base station controller (an RNC in a system such as the UMTS), in order to implement such a method.

A base station referenced Node B thus includes (in addition to other means which may be conventional means):
means referenced 13′ for signaling to a base station controller a resource model representative of its processing capacities, such that:
   if the second entity supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
   if the second entity supports only a resource model based on spreading factor, the information signaled by the second entity, representative of said second resource model, comprises only information representative of a resource model based on spreading factor.

A base station controller referenced RNC thus includes (in addition to other means which may be conventional means):
means referenced 14′ for receiving from a base station a resource model representative of its processing capacities, such that:
the second entity includes means for signaling to the first entity a resource model representative of its processing capacity, such that:
   if the second entity supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
   if the second entity supports only a resource model based on spreading factor, the information signaled by the second entity, representative of said second resource model, comprises only information representative of a resource model based on spreading factor;
means referenced 15′ for managing said processing resources on the basis of the signal resource model as a function of spreading factor and data rate or as a function of spreading factor only, as appropriate, for the allocated radio resources.

These various means can operate using the above-described method described above; the particular way in which they are embodied does not present any particular difficulty for the person skilled in the art, so such means do not need to be described herein in a manner more detailed than by describing their functions.

1. A method of managing processing resources in a mobile radio system, in which a “first” entity manages radio resources and corresponding processing resources, the processing resources being provided in a distinct, “second” entity, in which method:
the second entity signals to the first entity a resource model representative of its processing capacity, based on spreading factor and on data rate; and
the first entity manages said processing resources, on the basis of the signaled resource model, as a function of spreading factor and of data rate for the allocated radio resources.

2. A method according to claim 1, in which:
the information signaled by the second entity, representative of said resource model, comprise an overall processing capacity, or “capacity credit”, and a consumption law giving the quantity of said overall processing capacity that is needed for allocating radio resources, as a function of spreading factor and as a function of data rate; and
said management of processing resources by said first entity includes updating the capacity credit on each radio resource allocation, on the basis of said consumption law, as a function of spreading factor and of data rate for the allocated radio resources.

3. A method according to claim 1, in which the information signaled by the second entity, representative of said resource model based on spreading factor and on data rate, comprises “first” information representative of a resource model based on spreading factor and representative of a portion of said processing capacity, and “second” information representative of a resource model based on data rate and representative of another portion of said processing capacity.

4. A method according to claim 3, in which said first information comprises at least a “first” allocation cost corresponding to the quantity of overall processing capacity needed for radio resource allocation for a spreading factor value, and said second information includes at least a “second” allocation cost corresponding to the quantity of the overall processing capacity needed for radio resource allocation for a data rate value.

5. A method according to claim 4, in which different allocation costs are provided for different predetermined data values referred to as “reference” data rates.

6. A method according to claim 5, wherein the consumption cost for said corresponding bit rate is obtained from the consumption costs for reference bit rates.

7. A method according to claim 6, wherein the consumption cost for said corresponding bit rate is obtained from the consumption costs for reference bit rates by interpolation.

8. A method according to claim 7, wherein, when the bit rate R is not a reference bit rate, the consumption cost is calculated as a function of consumption costs C_{inf} and Cₛᵤₚ corresponding to the reference bit rates R_{inf} and Rₛᵤₚ that are the closest to the bit rate R and where R_{inf}<Rₛᵤₚ, in accordance with the following equation:
$${Consumption}_{—} cost = {C}_{inf} + \frac{R - {R}_{inf}}{{R}_{sup} - {R}_{inf}} ( {C}_{sup} - {C}_{inf} )$$

9. A method according to either claim 6, wherein the consumption cost is set at zero if the interpolation result is negative.

10. A method according to claim 5, wherein said corresponding bit rate corresponds to a maximum bit rate.

11. A method according to claim 10, wherein said maximum bit rate is obtained from the equation:
$${Maximum}_{—} {bit}_{—} rate = {Max}_{j} {br}_{j}$$
$$where \text{:}$$
$${br}_{j} = {\sum }_{k = 1}^{n} \frac{{N}_{k}^{( j )} {L}_{k}^{( j )}}{{TTI}_{k}}$$
and in which brⱼ is the bit rate of j^{th} transport format combination (TFC) in the TFCS, n is the number of transport channels in the CCTrCh, Nₖ⁽j) and Lₖ^{(j)} are respectively the number of transport blocks and the size of the transport blocks expressed as a number of bits for the k^{th} transport channel in the j^{th} TFC, and TTIₖ is the transmission time interval (TTI) expressed in seconds of the k^{th} transport channel.

12. A method according to claim 5, wherein said corresponding bit rate corresponds to an effective bit rate.

13. A mobile radio system including means for implementing a method according to claim 1.

14. A mobile radio system according to claim 13, including:
in the second entity, means for signaling to the first entity a resource model based on spreading factor and on data rate; and
in the first entity, means for managing said processing resources on the basis of the signaled resource model as a function of spreading factor and of data rate for the allocated radio resources.

15. A base station for a mobile radio system including means for implementing a method according to claim 1.

16. A base station according to claim 15, including:
means for signaling to a base station controller a resource model based on spreading factor and on data rate.

17. A base station controller for a mobile radio system including means for implementing a method according to claim 1.

18. A base station controller according to claim 17, including:
means for receiving from a base station a resource model based on spreading factor and on data rate; and
means for managing said processing resources on the basis of the signaled resource model as a function of spreading factor and of data rate for the allocated radio resources.

19. A method of managing processing resources in a mobile radio system, in which a “first” entity manages radio resources and corresponding processing resources, which processing resources are provided in a distinct, “second” entity, in which method:
the second entity signals to the first entity a resource model representative of its processing capacity, such that:
if the second entity supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
if the second entity supports only a resource model based on spreading factor, the information signaled by the second entity, representative of said second resource model, comprises only information representative of a resource model based on spreading factor;
the first entity manages said processing resources on the basis of the signaled resource model as a function of spreading factor and of data rate, or as a function of spreading factor alone, as the case may be, for the allocated radio resources.

20. A method according to claim 19, in which, if the second entity supports both a resource model based on spreading factor and on data rate, and a resource model based on spreading factor, it selects one of the two models as being more representative of its processing capacity, and it signals the selected resource model to the first entity.

21. A method according to claim 19, in which:
the information signaled by the second entity and representative of a resource model comprises an overall processing capacity or “capacity credit” and a consumption law indicating the quantity of said overall processing capacity that is needed for allocating radio resources as a function of both spreading factor and data rate, or as a function of spreading factor only, as appropriate; and
said management of processing resources by said first entity comprises updating the capacity credit on each radio resource allocation on the basis of said consumption law as a function of spreading factor and data rate or as a function of spreading factor alone, as appropriate, for the allocated radio resources.

22. A method according to claim 19, in which said first information comprises at least a “first” allocation cost corresponding to the quantity of overall processing capacity needed for allocating radio resources, for a value of spreading factor, and said second information comprises at least a “second” allocation cost corresponding to the quantity of overall processing capacity needed for allocating radio resources for a data rate value.

23. A mobile radio system including means for implementing the method according to claim 19.

24. A mobile radio system according to claim 23, in which:
the second entity includes means for signaling to the first entity a resource model representative of its processing capacity, such that:
if the second entity supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
if the second entity supports only a resource model based on spreading factor, the information signaled by the second entity, representative of said second resource model, comprises only information representative of a resource model based on spreading factor;
the first entity including means for managing said processing resources on the basis of the signaled resource model as a function of spreading factor and data rate or as a function of spreading factor alone, as appropriate, for the allocated radio resources.

25. A base station for a mobile radio system including means for implementing the method according to any one of claim 19.

26. A base station according to claim 25, including:
means for signaling to a base station controller a resource model representative of its processing capacity, such that:
if the base station supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
if the base station supports only a resource model based on spreading factor, the information signaled by the second entity, representative of said second resource model, comprises only information representative of a resource model based on spreading factor.

27. A base station controller for a mobile radio system including means for implementing a method according to claim 19.

28. A base station controller according to claim 27, including:
means for receiving from a base station a resource model representative of its processing capacity, such that:
if the base station supports a resource model based on spreading factor and on data rate, the information signaled by the second entity representative of said resource model comprises “first” information representative of a resource model based on spreading factor and representative of a portion of said processing capacity, and “second” information representative of a resource model based on data rate and representative of another portion of said processing capacity; and
if the base station supports only a resource model based on spreading factor, the information signaled by the second entity, representative of said second resource model, comprises only information representative of a resource model based on spreading factor;
means for managing said processing resources on the basis of the signaled resource model as a function of spreading factor and of data rate, or as a function of spreading factor alone, as appropriate, for the allocated radio resources.
